(19) United States
(12) Patent Application Publication
(10) Pub. No.: US 2009/0237506 A1
(43) Pub. Date: Sep. 24, 2009

(54) System for Communication Between a Video Image Acquisition Unit and an on-Board Computer for a Motor Vehicle

(75) Inventors: Vincent Hubert, Pontoise (FR); Marc Semelle, Montigny-Le-Bretonneux (FR)

Correspondence Address: OLIFF & BERRIDGE, PLC, P.O. BOX 320850, ALEXANDRIA, VA, 22320-4850, US

(73) Assignee: VALEO ETUDES ELECTRONIQUES, CRETEIL (FR)

(21) Appl. No.: 12/083,345

(22) PCT Filed: Oct. 11, 2006
(86) PCT No.: PCT/FR2006/051016

§ 371 Date: Jun. 16, 2008

(30) Foreign Application Priority Data
Oct. 12, 2005 (FR) 0510423

(51) Int. Cl. H04N 7/18

(52) U.S. Cl. 348/148

(57) ABSTRACT

The communications system (12) between the video image acquisition unit (14) and the on-board computer (16) includes means for transmitting data by carrier current comprising a data transmission line (20) forming a circuit for electrically powering members of the motor vehicle. The system (12) further comprises first means (22) for putting a video data set into the form of a first digital signal transmitted on a first set of carrier frequencies, and second means (24) for putting a control data set into the form of a second digital signal transmitted on a second set of carrier frequencies, the number of carrier frequencies in the first set being greater than the number of carrier frequencies in the second set.

The present invention relates to a communications system between a video image acquisition unit and an on-board computer for a motor vehicle, and it also relates to a communications method.

In the state of the art, there is already known a communications system between a video image acquisition unit and an on-board computer for a motor vehicle, the system comprising means for transmitting data by carrier current comprising a data transmission line forming a circuit for electrically powering members of the motor vehicle.

The video image acquisition unit generally comprises a video camera, e.g. placed at the rear of the vehicle.

The on-board computer is generally connected to a screen displaying the video image coming from the image acquisition unit.

The driver can thus see obstacles behind the vehicle from the image on the screen.

Proposals have been made in particular for a video image acquisition unit that transmits video data to the on-board computer in the form of an analog signal modulating a power supply current flowing in the electrical power supply circuit.

The video image acquisition unit and the on-board computer also exchange control data for the video image acquisition unit, e.g. to adjust parameters or the position of the video image acquisition unit, to activate or deactivate the video image acquisition unit, etc.

In general, such control data is transmitted over one or more lines that are distinct from the video transmission line.

Consequently, the communications system between the video image acquisition unit and the on-board computer is relatively complex.

A particular object of the invention is to simplify the communications system between the image acquisition unit and the on-board computer while enabling control data and video data to be transmitted reliably.

To this end, the invention provides a communications system of the above-specified type, characterized in that it comprises first means for putting a video data set into the form of a first digital signal transmitted on a first set of carrier frequencies, and second means for putting a control data set into the form of a second digital signal transmitted on a second set of carrier frequencies, the number of carrier frequencies in the first set being greater than the number of carrier frequencies in the second set.

Thus, since the number of carrier frequencies allocated to transmitting the control data digital signal is smaller than the number of carrier frequencies allocated to transmitting video data, it is possible to transmit the control data at a low rate and the video data at a high rate simultaneously over the line that forms the electrical power supply circuit.

Furthermore, transmitting video data and control data in the form of digital signals on distinct sets of carrier frequencies makes it possible to limit interference between the various digital signals.

As a result, the communications system is simpler and is particularly reliable, since making use of data transmission in the form of digital signals makes it relatively easy to include therein means for detecting and correcting errors.

A communications system of the invention may further comprise one or more of the following characteristics:
the system includes selector means for selecting the carrier frequencies of the first set of carrier frequencies as a function of a predetermined criterion;
the predefined criterion is associated with an error rate in the transmission of test data between the on-board computer and the video image acquisition unit;
the predefined criterion is associated with an attenuation level of a characteristic of a test signal transmitted between the on-board computer and the video image acquisition unit;
the video image acquisition unit includes means for forming an optical image having an angular field of view greater than 120°; and
the means for forming the optical image comprise a fish-eye type lens.

The invention also provides a method of communicating between at least one video image acquisition unit and an on-board computer for a motor vehicle, the method being of the type in which data is transmitted by carrier current between the video image acquisition unit and the on-board computer, and being characterized in that a video data set is put into the form of a first digital signal transmitted on a first set of carrier frequencies, and a control data set is put into the form of a second digital signal transmitted on a second set of carrier frequencies, the number of carrier frequencies in the first set being greater than the number of carrier frequencies in the second set.

A communications method of the invention may further comprise one or more of the following characteristics:
the carrier frequencies of the first set are selected as a function of a predefined criterion, prior to each transmission of at least a portion of the first video data set;
the carrier frequencies of the first and second sets of carrier frequencies are selected from at least 100 successive carrier frequencies;
the predefined criterion is associated with an error rate in the transmission of test data between the on-board computer and the video image acquisition unit;
the predefined criterion is associated with an attenuation level of a characteristic of a test signal transmitted between the on-board computer and the video image acquisition unit; and
for communicating between at least two video image acquisition units and the on-board computer, a control data set is sent for the attention of a first one of the two image acquisition units, and a video data set is acquired by means of the first unit, while sending for the attention of the on-board computer, a video data set acquired by the second one of the two image acquisition units.

The invention can be better understood on reading the following description given purely by way of example and made with reference to the accompanying drawings, in which:

FIG. 1 is a diagrammatic view of a motor vehicle including a communications system constituting a first embodiment of the invention;

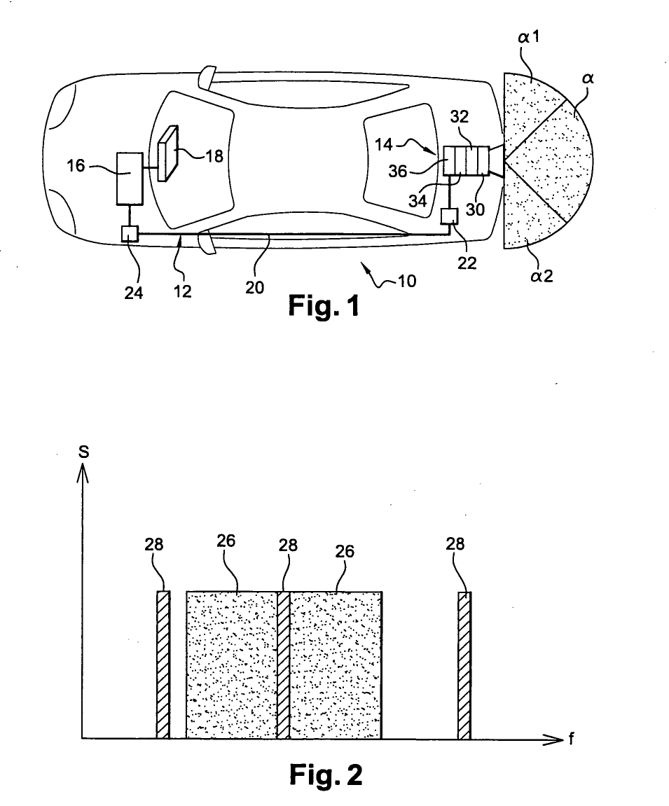

FIG. 2 is a graph showing a frequency spectrum of first and second digital signals corresponding respectively to video data and to control data;

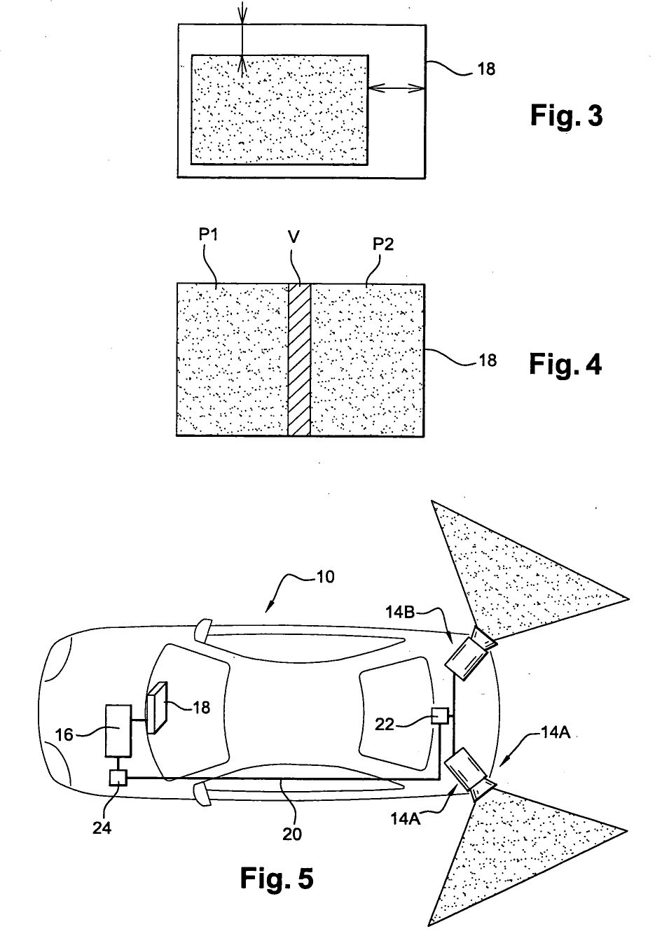

FIG. 3 is a diagrammatic view of a screen of the communications system shown in FIG. 1, for displaying a useful video image;

FIG. 4 is a view similar to FIG. 3 showing another useful video image;

FIG. 5 is a view similar to FIG. 1 showing a motor vehicle fitted with a communications system constituting a second embodiment of the invention;

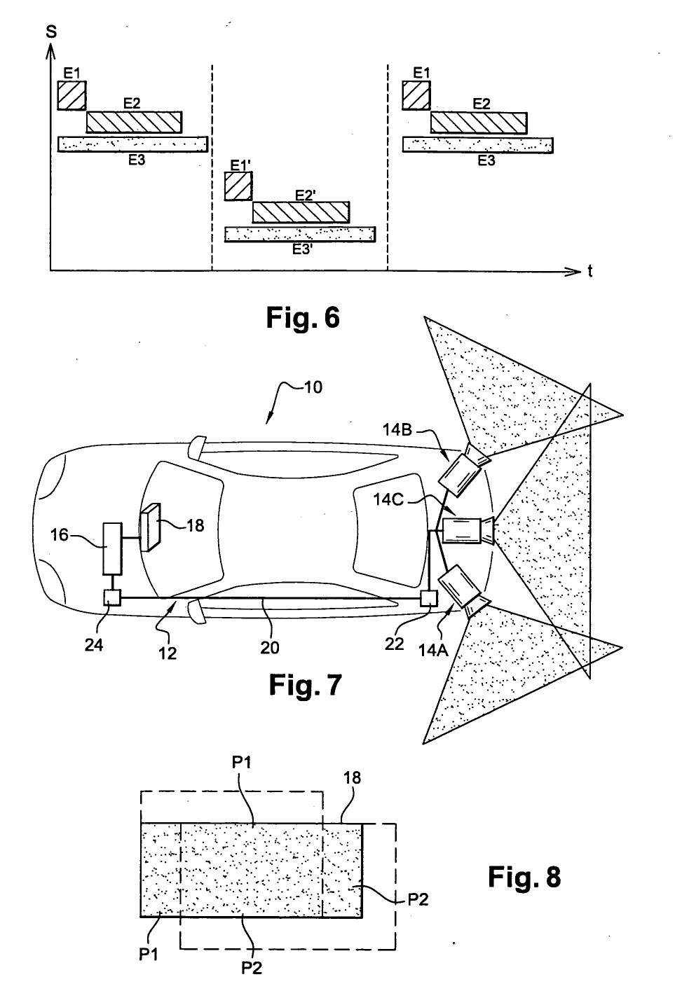

FIG. 6 is a graph showing a succession of video and control data digital signals transmitted in the communications system shown in FIG. 5;

FIG. 7 is a view similar to FIG. 1 showing a motor vehicle provided with a communications system constituting a third embodiment of the invention; and

FIG. 8 is a view of the screen showing a useful image obtained from the communications system shown in FIG. 7.

FIG. 1 shows a motor vehicle provided with a video data processor device constituting a first embodiment of the invention. The processor device is given overall reference 10.

The processor device 10 comprises a communications system 12 for communicating between a video image acquisition unit 14 and an on-board computer 16 of the motor vehicle.

The computer 16 is connected to a conventional screen 18 for displaying a useful video image that is visible to the driver of the vehicle.

The communications system 12 includes carrier current data transmission means comprising a data transmission line 20 forming a circuit for electrically powering various members of the motor vehicle, and in particular the video image acquisition unit 14.

The communications system 12 also comprises first means 22, e.g. a conventional module for carrier current data transmission, for putting a video data set into the form of a first digital signal, and second means 24, e.g. a second conventional module for carrier current data transmission, for putting a control data set into the form of a second digital signal.

As can be seen in FIG. 2, the first digital signal (video data) is transmitted by a first set 26 of carrier frequencies, and the second digital signal (control data) is transmitted by a second set 28 of carrier frequencies.

The video image acquisition unit 14 includes means 30 for forming an optical image, which means comprise, in the first embodiment described, an objective lens of the fish-eye type. This lens serves to form an optical image having an angular field of view of greater than 120°.

The video image acquisition unit 14 also includes conventional means 32 for generating an initial video image from the optical image formed by the means 30.

The video image acquisition unit 14 also includes means for creating a useful video image from the initial video image as generated by the means 32. These useful video image image-creator means comprise adjustable connector means 34 for adjustably selecting at least a portion of the initial video image, the selected portion constituting at least a portion of the useful video image.

The video image acquisition unit 14 also includes means 36 for selecting carrier frequencies of the first set 26 of carrier frequencies (data signal), as a function of a predefined criterion.

In a variant, the carrier frequency selector means 36 could be arranged in some other element of the communications system 12.

The main aspects of a method of the invention for communication between the image acquisition unit 14 and the on-board computer 16 are described below.

During this method, data is transmitted by carrier current, making use of the transmission line 20 between the video image acquisition unit 14 and the on-board computer 16.

Initially, the means 34 are used to select a portion of the initial video signal generated by the means 22, e.g. a portion corresponding to a central spherical angular sector α of the optical image formed by the fish-eye lens, as shown in FIG. 1. The portion selected is for constituting the useful video image.

Where present, the portion of the initial video image that is selected is adjusted in order to take account of variations in the position of the video image acquisition unit 14 with this being done with the help of a conventional user interface and software means included in the on-board computer 16.

FIG. 3 has arrows representing the abscissa and ordinate adjustments that it is possible to apply to the useful image as displayed on the screen 18 by adjusting which portions of the initial video image are selected.

Where appropriate, the adjustable selector means 34 enable at least two portions of the initial video image to be selected, e.g. two side spherical angular sectors α1 and α2 that are disjoint in the optical image, as shown in FIG. 1.

The selected portions of the initial video image constitute at least two portions P1, P2 of the useful image, as shown in FIG. 4.

The two useful image portions P1, P2 may optionally be separated by a vertical strip V informing the user that the useful image portions P1, P2 come from two disjoint portions of the optical image.

The selected portion of the initial video image forms a video data set that is put into the form of the first digital signal with the help of the means 22. This first signal is for sending to the screen 18 via the computer 16.

Before transmitting the video data set or a portion of this video data set, the means 36 are used to select the carrier frequencies for the first carrier frequency 26 as a function of a predefined criterion.

By way of example, this criterion may be associated with the error rate in the transmission of test data between the on-board computer 16 and the video image acquisition unit 14.

Thus, test data is transmitted over all of the carrier frequencies usable for transmitting video data, and then as a function of an error rate in the transmission of the test data, those carrier frequencies that are the most disturbed are eliminated so as to conserve as a general rule about 80% of the potential carrier frequencies.

In a variant, the criterion is associated with an attenuation level for a characteristic of the test signal transmitted between the on-board computer 16 and the video image acquisition unit 14. For example, the signal characteristic may be an amplitude of the test signal.

Furthermore, the video image acquisition unit 14 and the on-board computer 16 also exchange control data for the video image acquisition unit 14, e.g. to adjust parameters or the position of the video image acquisition unit, to activate or deactivate the video image acquisition unit, etc.

Thus, the video image acquisition unit 14 is controlled in particular in order to enable it to acquire a new initial video image.

For this purpose, a control data set is formed with the help of the means 24 so as to constitute a second digital signal that is transmitted from the on-board computer 16 to the unit 14 using the second set of carrier frequencies 28.

In order to able to transmit the video data at a rate that is sufficiently high from the unit 14 to the computer 16 and the screen 18, the number of carrier frequencies in the first set 26 (video data) is greater than the number of carrier frequencies in the second set 28 (control data).

Preferably, the carrier frequencies of the first and second sets 26 and 28 of carrier frequencies are selected from at least 100 successive carrier frequencies, e.g. 128 carrier frequencies.

The 128 successive carrier frequencies are distributed for example over the range 2 megahertz (MHz) to 30 MHz.

In the example shown in FIG. 2, the carrier frequencies of the second set 28 (control data) are located to the left, to the right, and substantially in the middle of the carrier frequencies of the first set 26 (video data). In a variant, the carrier frequencies of the second set 28 could be situated solely to the left of the carrier frequencies of the first set 26, or solely to the right of the carrier frequencies of the first set 26, or indeed solely between carrier frequencies of the first set 26.

FIGS. 5 to 8 show video data processor devices 10 constituting second and third embodiments of the invention.

In these figures, elements analogous to those in the preceding figures are identified by identical references.

The processor device 10 of the second embodiment shown in FIG. 5 comprises two video image acquisition units 14A, 14B analogous to the above-described video image acquisition unit 14.

These two units 14A, 14B are connected to the same line 20 for transmitting data by carrier current.

Preferably, and as shown in FIG. 6, a control data set E1 is sent for the attention of a first one 14A of these two image acquisition units and a video data set E2 is acquired by means of the first unit 14A, while at the same time a video data set E3 that has been already acquired by the second one 14B of the two image acquisition units is sent for the attention of the on-board computer 16.

Once E3 has been sent, a control data set E1′ is sent for the attention of the second unit 14B and a video data set E2′ is acquired by means of the second unit 14B, while a video data set E3′ that has been already acquired by the first unit 14A is sent for the attention of the on-board computer 16, etc.

For reasons of clarity, in FIG. 6, the sending of the data set E1′ is shown separated from the sending of the data set E3. Nevertheless, in general, the sending of the set E1′ follows on directly from the sending of the set E3.

In this second embodiment, each unit 14A, 14B generates an initial video image and the adjustable selector means 32 of each unit 14A, 14B select a portion of the corresponding initial video image.

The two selected portions of the two initial video images constitutes at least two useful image portions P1, P2, as shown in FIG. 4.

The communications system 12 constituting the third embodiment as shown in FIG. 7 has three video image acquisition units 14A, 14B, 14C analogous to the above-described video image acquisition unit 14.

These three units 14A, 14B, 14C are connected to the same line 20 for transmitting data by carrier current.

As for the second embodiment, a control data set is sent to the attention of the first of the three video image acquisition units 14A, 14B, 14C and a video data set can be acquired by said first of these three image acquisition units while a second one of the three image acquisition units is sending for the attention of the on-board computer 16 a video data set that has been acquired by said second one 14B of the three image acquisition units.

Furthermore, as shown in FIG. 8, the useful image displayed on the screen 18 may be made up of two image portions P1, P2 coming from two of the three image acquisition units 14A, 14B, 14C, in particular when the optical image forming means 30 of the two units 14A, 14B, 14C in question present angular fields of view that overlap in part, as shown in FIG. 7.

Thus, a useful video image can be displayed on the screen 18 occupying an apparent angular field of view that is greater than the angular field of view of any one of the image acquisition units 14A, 14B, 14C.

1. A communications system between a video image acquisition unit and an on-board computer for a motor vehicle, the system comprising means for transmitting data by carrier current comprising a data transmission line forming a circuit for electrically powering members of the motor vehicle, the system comprises first means for putting a video data set into the form of a first digital signal transmitted on a first set of carrier frequencies, and second means for putting a control data set into the form of a second digital signal transmitted on a second set of carrier frequencies, the number of carrier frequencies in the first set being greater than the number of carrier frequencies in the second set.

2. A communications system according to claim 1, including selector means for selecting the carrier frequencies of the first set of carrier frequencies as a function of a predetermined criterion.

3. A communications system according to claim 2, in which the predefined criterion is associated with an error rate in the transmission of test data between the on-board computer and the video image acquisition unit.

4. A communications system according to claim 2, in which the predefined criterion is associated with an attenuation level of a characteristic of a test signal transmitted between the on-board computer and the video image acquisition unit.

5. A communications system according to claim 1, in which the video image acquisition unit includes means for forming an optical image having an angular field of view greater than 120°.

6. A communications system according to claim 5, in which the means for forming the optical image comprise a fish-eye type lens.

7. A method of communicating between at least one video image acquisition unit and an on-board computer for a motor vehicle, the method being of the type in which data is transmitted by carrier current between the video image acquisition unit and the on-board computer, wherein a video data set is put into the form of a first digital signal transmitted on a first set of carrier frequencies, and a control data set is put into the form of a second digital signal transmitted on a second set of carrier frequencies, the number of carrier frequencies in the first set being greater than the number of carrier frequencies in the second set.

8. A communications method according to claim 7, in which the carrier frequencies of the first set are selected as a function of a predefined criterion, prior to each transmission of at least a portion of the first video data set.

9. A communications method according to claim 8, in which the carrier frequencies of the first and second sets of carrier frequencies are selected from at least 100 successive carrier frequencies.

10. A communications method according to claim 8, in which the predefined criterion is associated with an error rate in the transmission of test data between the on-board computer and the video image acquisition unit.

11. A communications method according to claim 8, in which the predefined criterion is associated with an attenuation level of a characteristic of a test signal transmitted between the on-board computer and the video image acquisition unit.

12. A method according to claim 7, for communicating between at least two video image acquisition units and the on-board computer, in which a control data set is sent for the attention of a first one of the two image acquisition units, and a video data set is acquired by means of the first unit, while sending for the attention of the on-board computer, a video data set acquired by the second one of the two image acquisition units.
